(19) United States
(12) Patent Application Publication
(10) Pub. No.: US 2008/0131557 A1
(43) Pub. Date: Jun. 5, 2008

(54) PROCESS OF MAKING PASTA FILATA

(76) Inventors: M. Giama Isse, St-Hubert (CA); Luc Savoie, MacMasterville (CA)

Correspondence Address: PETER F WEINBERG;GIBSON DUNN AND CRUTCHER LLP, SUITE 4100, 1801 CALIFORNIA STREET, DENVER, CO, 80202, US

(21) Appl. No.: 11/566,593

(22) Filed: Dec. 4, 2006

(51) Int. Cl. A23C 9/12; A23C 19/068

(52) U.S. Cl. 426/39; 426/582

(57) ABSTRACT

A pasta filata making process with (A) Better recuperation of solids (B) Better moisture control and (C) Larger window of cheese performance, in terms of target functionalities such as melt, stretch, oiling off, blistering. This is done by combining a targeted curd mineralization (more or less interconnected casein matrix) and the use of microwave-cooker-stretcher system that allows a more efficient recuperation of solids and a more efficient reduction of the residual enzymes. Pasta filata curd is heated in a microwave to temperatures between 125 and 165 F, then molded and cooled. The aspect mentioned in (A) and (B) addresses the need of manufacturers to have more efficient process while (C) addresses the need of end users to have more flexibility in the usage of the cheese.

### FIELD OF THE INVENTION

This invention relates to the field of making pasta filata cheese. More particularly, it relates to a process using a microwave system in the cooking and stretching steps.

### BACKGROUND

Pasta filata is one of most popular cheese in North America. It is used mainly as an ingredient for pizza, and requires target functionalities. The most well known pasta filata is mozzarella, which can be made according to the invention, although the invention is not so limited.

Pasta filata is usually made by the following steps: 1) Standardizing (typically) cow milk to a desired fat and protein level, 2) Pasteurizing, 3) Acidifying with bacterial culture or acid 4) Adding coagulating enzymes to form a coagulum or gel (either term encompassing the other herein), 5) Cutting the gel 6) Cooking to temperatures around 113 F to reduce moisture in the coagulum 7) Draining of the whey, 8) Cooking and stretching of the curd, 9) Molding the curd following by immersion in cold brine.

For the cooker-stretcher step for pasta filata, a circulating hot water system is usually used. This heats the mass of curd to the target temperature (usually between 125 and 142 F). In this step a significant amount of cheese solids is lost to the cooker water. Significant amount of resources are dedicated for the recovery of the solids and the disposal of liquids.

The traditional hot water cooker-stretcher does not allow a good control of the moisture. It is also difficult to stretch the curd if its pH falls below pH 5.00. In such situation any run away acidity results in product downgrade.

The steam injection cooker, in which curd is heated by direct steam injection, has some advantages in controlling the moisture. However, it has the disadvantage of condensate formation and the loss of solids, particularly at higher pH curd.

Pasta filata cheese needs to mature for a period of time before it is ready to exhibit the target functionality. But after a period of time, the product loses its functionality, thus the cheese has a performance window.

To reduce inventory, there is always a need to have faster maturation.

To have flexibility of usage, there is also the need to have wider performance window for the cheese.

Most of the time, these two goals are in conflict, as the steps that accelerate maturation lead usually to shorter performance window.

U.S. Pat. No. 5,200,216 describes a method of making pasta filata without aging, by increasing the combined moisture and wet milk fat to a maximum level of 70%.

There are also several publications mentioning the use of enzymes to accelerate ripening.

US Pat. 2002/0127301 A1 describes a method for making pasta filata by using a mix of frozen base curd and cultured skim milk.

However, any enhanced action of the proteolytic enzymes (either by increased addition of these enzymes or through increased water activity such as higher moisture or higher wet fat) that accelerates the casein breakdown before freezing also shortens the window of performance (as the enzymes continue to be active). For example, in the case of frozen mozzarella, the cheese has to show good functionality for at least 10 days (or other time period according to user demands) after thawing.

There is a double need to: 1) Have a process with higher efficiency in recuperation of solids at the cooker stretcher level 2) Have a process that can cut the maturation time of the cheese and increase the performance window for the end users. The present invention solves both of these needs.

### BRIEF DESCRIPTION OF THE DRAWINGS

FIG. 1, comprising Table 1 and 2, show test data of controls and samples prepared according to aspects of the invention.

FIG. 2 is a diagram showing the steps of the process of an embodiment of the invention.

### DETAILED DESCRIPTION

The one step that mostly characterizes pasta filata is the cooker stretcher.

This step is important for the efficiency of the whole process. If significant quantities of solids are lost to the cooker water, the cost of the final product would be increased, as resources must be dedicated to recover solids and dispose liquids.

A flexible process that allows a better control of the moisture of the final product and at the same time allows handling curds at lower pH would give flexibility to processing plants and would reduce the number of vats lost due to out of specification and to the occasional run away acidity.

The way the cooker-stretcher is carried out also affects the cheese functionality, by orienting the fibers, determining the level of residual enzymes and thus impacting the performance window of the cheese.

Definitely a processing and functionality requirement are inter-linked by the cooker-stretcher and present opportunity for “one-stop” solution.

Natural pasta filata cheese requires a period of maturation to exhibit desired functionality such as melt, stretch, oiling, blistering etc.

The maturation process is basically the breakdown of the casein matrix through proteolytic enzymes, such as the residual rennet in the curd (which provides the primary proteolysis), and the enzymes from the bacterial culture (which provide the secondary proteolysis, breaking down further the products of the primary proteolysis).

If the casein matrix is too interconnected (young cheese), individual shred would be visible on the pizza and functionality would be limited. If the cheese is too broken down, it will be runny, weak and without desired functionality. Optimal functionality is exhibited when some breakdown of the casein has taken place, but to a limited extent.

The maturation rate is affected by factors such as the level of different proteolytic enzymes, the level of colloidal calcium, the maturation temperature and the water activity of the curds/cheese.

To accelerate the maturation of pasta filata cheese, usually the same methods are used as for other cheese, such as additional proteolytic enzymes, or increasing the water activity level though increased moisture or wet fat.

These methods are effective in reducing maturation time, but they present the disadvantage of shortening the window of performance of the cheese, reducing the end-use flexibility.

This invention regards a process that allows reaching two main objectives: 1) increasing the efficiency of the cooker-stretcher steps and 2) Widen the performance window of the pasta filata cheese.

The double objective is achieved by using a microwave system as a cooker stretcher. As there is no cooker water, the loss of cooker juice is eliminated (better recuperation of solids). A microwave system as used herein means any device or method for heating using microwaves. Such systems are well known in the general fields of cooking and food processing, although not, it is believed, in the context of the present invention.

As the microwave allows stretching at lower pH, curd can be demineralized to any target point from the usual ranges of pH 5.20±0.15 to a lower range of pH 4.90±0.15. The lower pH range means less colloidal calcium in the cheese, better hydration of the protein, and cheese that is closer to its performance window.

Moreover, a microwave heating system will first raise the temperature of water-phase and with it the water-soluble enzymes. This results in more efficient denaturation of the proteolytic enzymes. This reduction of the residual enzymes results in more moderate protein breakdown.

The combination of cheese that is closer to its performance window (because demineralization) and yet has less proteolytic enzymes (because microwave de-activation of the enzymes) would result in wider window of performance, which starts at earlier times.

A combination of highly mineralized cheese and microwave-stretcher cooker will achieve a cheese with a good shelf life.

The manufacturing steps according to the present invention may be those standard for pasta filata cheese, typically including but not limited to pasteurizing the milk, adding culture, adding coagulant, cutting the curd, cooking it, and separating the whey. Curd could also be made through a wheyless process

The resulting curd is transferred to a microwave cooker, and heated to temperatures between 125 F and 165 F, then stretched, molded and cooled.

The microwave cooker system is used mainly for the following purposes: (1) Better recuperation of solids, as no cooker juice is generated, (2) Better controlling the moisture, as there is no water uptake at the cooking and stretching stage, (3) Stretching the curd at any target pH, particularly the lower range of pH below the 5.00.

It is optional to combine the above process with a very high demineralization of the curd (very low pH) and dry salting before, during or after stretching.

A lower mineralization level (lower pH) helps reduce the interconnection of the casein matrix.

Salting of the curd before or during the stretching would help the curd better hydrate and also lower the water activity right from the start, improving the window of performance.

The addition of flavor and/or functional ingredients at any stage is also optional.

Separate or combined microwave heating and mechanical stretches are optional.

The microwave system could equally be applied to a process where a wheyless curd is made by using a pre-concentrated dairy mix having the same moisture as the final cheese.

The microwave system is understood as the microwave heating and further the mechanical kneading and stretching, which could be one step or two separate steps.

For the first example of control pasta filata cheese, the following make-procedure was used: 1) Vat milk standardized to a fat/protein ratio of 0.69, 2) Pasteurized and cooled to 89 F, 3) Inoculated with bacterial culture at 0.45% (w/w) for 30 minutes; 4) Added coagulating enzymes at the rate of 109 ml/1000 liters of vat fill; 5) Cut the coagulum after 17 minutes and 6) start cooking to 113 F, 7) Started to transfer the cheese to a table at pH 6.35 and finished whey drained at pH 6.12; 8) Cheese was let to stay on the table until a pH around 5.06 was reached and then sent to a traditional hot-water cooker stretcher operating between 125 and 145 F; 9) molded, cooled and packaged.

For the test pasta filata, the same steps as the control were followed to step 8. At this point the cheese is 9) acidified longer for 45 minutes to pH around 4.90; 10) cheese sent to microwave cooker and stretched, cooled to the same temperature as the control and packaged.

For both control and tests, pizza performance was checked at 4, 7 and 14 days. The test outperformed the control at 4 days and kept its performance to 14 days.

For the second example of control pasta filata cheese, the following make-procedure was used: 1) Vat milk standardized to a fat/protein ratio of 0.79, 2) Pasteurized and cooled to 90 F 3) Inoculated with bacterial culture at 0.55% (w/w) for 30 minutes; 4) added coagulating enzymes at the rate of 123 ml/1000 liters of vat fill; 5) Cut the coagulum after 17 minutes and 6) start cooking to 113 F, 7) Started to transfer the cheese to a table at pH 6.33 and finished whey drained at pH 5.68; 8) Cheese was let to stay on the table until a pH around 5.00 was reached and then sent to a traditional hot-water cooker stretcher operating between 125 and 145 F, 9) molded, cooled and packaged.

For the tests pasta filata, the same steps as the control were followed to point 8. At this point the cheese is 9) acidified longer for 25 minutes to pH around 4.90; 10) cheese sent to microwave cooker and stretched, cooled to the same temperature as the control and packaged.

For both control and tests pizza performance was checked at 2, 5, 7, 9, 12 and 14 days. Tests and control performed in similar way until 12 days, after that the control's texture and performance were finished.

The tests outperformed the control at 4 days and kept its performance to 14 days. The control at 14 days was completely finished; however the tests continued to perform at the same level as day 5.

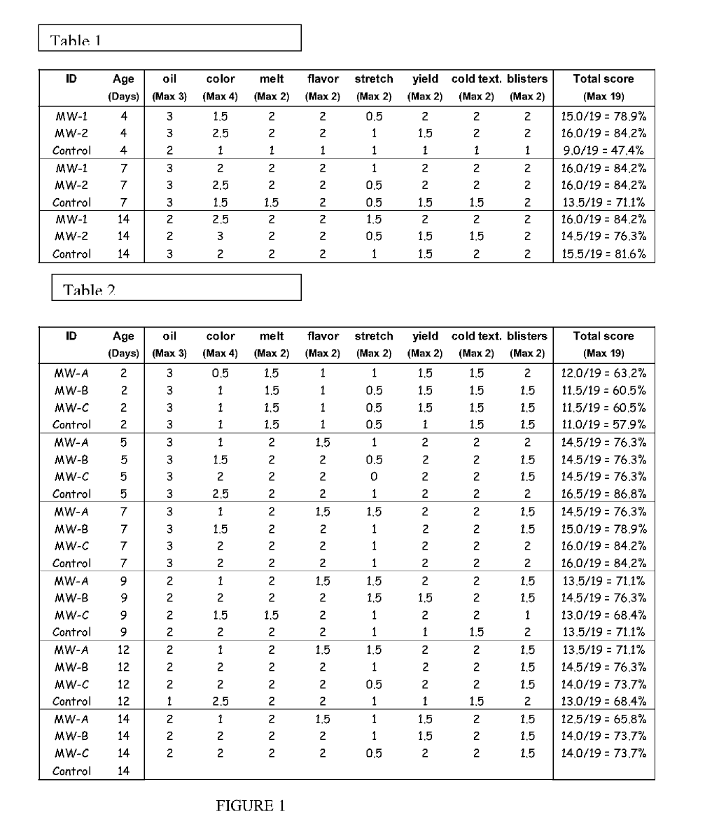

Pizza evaluation follows the following criteria: 1) Oiling off with maximum score of 3 (best) and 0 being unacceptable, 1 fair, 2 good. 2) Color with maximum score of 4 (best) 0 unacceptable, 1 poor, 2 average, and 3 good. All other characteristics (melt, flavor, stretch, yield, cold texture and blisters) have a maximum score of 2 (best), 0 unacceptable, 1 good, and 2 best. Fractional scores are admitted (like 1.5 for stretch). The total maximum score is 19 and the cheese on the pizza would have a total score between 0 and 19. For detailed numbers, see table 1 and table 2, which are in FIG. 1 hereto.

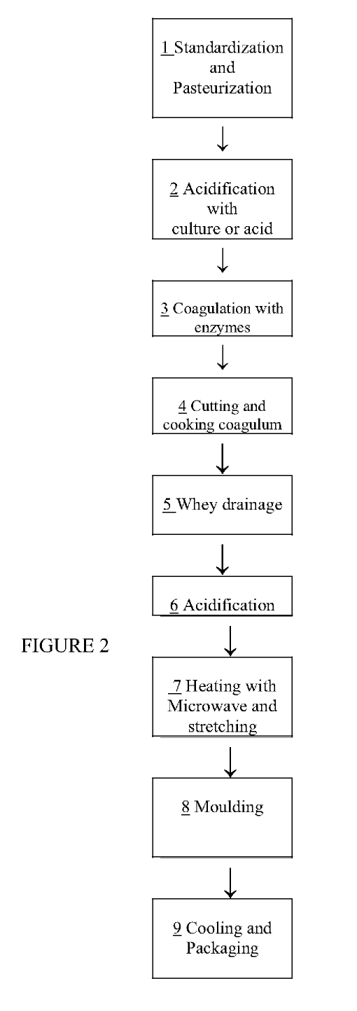

The overall process of the microwave system for pasta filata proceeds, as shown in FIG. 2, with (1) Standardization and pasteurization (2) Acidification with bacterial culture or with acid (3) Coagulation with enzymes (4) Cutting of the coagulum and cooking to a target temperature (5) Whey drainage using tables or belt systems like DMC, (6) Acidification to target level of mineralization (7) Heating with a microwave system that at the same time kneads and stretches the curd, immediately after heating to a target temperature, or during the heating, (8) molding of the homogeneous mass of cheese, (9) cooling and packaging.

What is claimed is:

1. A process for making pasta filata cheese, comprising the following steps:
(a) establishing a quantity of milk,
(b) acidifying the milk;
(c) coagulating the resulting acidified milk to form coagulum;
(d) cutting the coagulum to obtain curds and cooking the curds to a target temperature;
(e) draining whey from the curds, in the case whey is generated;
(f) acidifying the curds to a target level of mineralization to form a product;
(g) heating the product with a microwave system; and
(h) stretching the product.

2. The process of claim 1, wherein the establishing a quantity of milk step includes pasteurizing the milk.

3. The process of claim 1, further comprising the steps of molding the product, cooling it, and packaging it to form a finished product.

4. The process of claim 1, wherein step (f) acidifies the curds to a pH of less than about 5.10.

5. The process of claim 4, wherein step (f) acidifies the curds to a pH of between about pH 5.05 to 4.75.

6. The process of claim 1, wherein step (h) is performed after step (g).

7. The process of claim 1, wherein steps (g) and (h) are performed at least in part at the same time.

8. The process of claim 1, wherein the process includes salting.

9. The process of claim 8, wherein the salting is done before or during the stretching step.

10. The process of claim 1, further comprising adding flavor or functional ingredients, or both, to any step.

11. The process of claim 1, wherein steps (g) and (h) are performed in the same location.

12. The process of claim 1, wherein steps (g) and (h) are performed in different locations.

13. In a method of making cheese of the type where a dairy precursor is coagulated with enzymes, cut, drained of whey, if whey has been produced, acidified to a target level of mineralization, then heated and stretched, wherein the improvement comprises that the precursor is heated using a microwave system.

14. The method of claim 13, wherein the precursor is acidified to a pH of between about pH 5.05 to 4.75 before it is heated and stretched.

15. A pasta filata made by the process of coagulating a dairy precursor with enzymes, cutting, draining of whey, if whey has been produced, acidifying to a target level of mineralization, heating with a microwave system, and stretching.

16. The pasta filata of claim 15, wherein the precursor is acidified to a pH of about 5.05 to 4.75 before the heating and stretching.
